(19) United States
(12) Patent Application Publication
(10) Pub. No.: US 2012/0201924 A1
(43) Pub. Date: Aug. 9, 2012

(54) QUINOA-BASED BEVERAGES AND METHOD OF CREATING QUINOA-BASED BEVERAGES

(76) Inventor: Joseph I. Kamelgard, West Orange, NJ (US)

(21) Appl. No.: 13/363,615

(22) Filed: Feb. 1, 2012

Related U.S. Application Data
(63) Continuation of application No. PCT/US2011/023578, filed on Feb. 3, 2011.

(51) Int. Cl. C12C 11/00; C12G 3/12; C12C 12/00; C12C 7/00

(52) U.S. Cl. 426/13; 426/16; 426/14

(57) ABSTRACT

A method of brewing a quinoa-based beverage is made by pre-conditioning a quinoa grain to remove unpleasant flavors from the quinoa. The quinoa grain is then soaked and malted (germinated). After germinating, the quinoa grain is kilned and optionally milled. The quinoa grain is mashed to form a wort, and boiled, optionally using hops, clarifiers, and any other flavorants. The wort is then cooled down to fermentation temperatures, and a Kosher yeast like Saccharomyces cerevisiae added to the wort to ferment. The fermented wort is then optionally conditioned or collected for distillation. The final product is immunochemically safe and gluten-free. Further, provided the product is brewed with Kosher for Passover yeast and in Kosher for Passover facilities, the end product is both Kosher and Kosher for Passover. The fermented quinoa beverage may alternatively be distilled, and aged in Kosher and gluten-free casks, to form a Kosher and gluten-free distillate liquor.

### CROSS REFERENCE TO RELATED APPLICATIONS

This application is a continuation of prior filed International Application, Serial Number PCT/US2011/023578 filed Feb. 3, 2011, which is hereby incorporated by reference into this disclosure.

### FIELD OF INVENTION

This invention relates to methods of processing quinoa (Genus: Chenopodium, Species: quinoa, Family: Chenopodiaceae) grain (also called quinoa seed, quinoua, grain-like seed, pseudocereal, and fruit) to produce beverages, such as brewed and distilled alcoholic beverages.

### BACKGROUND OF THE INVENTION

Quinoa is grain that is native to the Andean region of South America named for its production of small grain-like seeds, although the actual harvested grain is a single seeded fruit (Shewry, P R (2002) In: Belton P S, Taylor J. eds. Pseudocereals and Less Common Cereals. Germany: Springer-Verlag Berlin Heidelberg. ppg. 93-122). The grain has been a major food source for about 6,000 years, serving as a staple food for native inhabitants of the region including the countries of Chile, Peru and Bolivia. Following the arrival of the Spanish in about 1500, quinoa production began to decline in the region, eventually becoming a minor crop that was grown only in remote regions for local consumption.

Unlike other staple food sources from the New World, such as potatoes and maize, quinoa was not widely adopted or spread throughout the globe. Quinoa has only been grown outside of South America for a relatively short time. Since 1975, quinoa has become an alternative crop in North America and Europe, partially because quinoa has the ability to thrive in marginal soils where traditional crops grow poorly. Quinoa has an average protein content of 14.6%, which is higher than traditional cereals, with certain varieties containing protein levels as high as 21.9%, and quinoa has an amino acid composition, protein efficiency ratio, protein digestibility, and nitrogen balance comparable to the milk protein casein (Fleming and Galwey (1995) In: Williams, J T, editor. Underutilized Crops: Cereals and Pseudocereals. New York: Chapman and Hall, pp. 3-83). Plant proteins, such as those from cereal grains, wheat gluten, rice, and corn, and legumes and soy, are useful ingredients in a wide variety of commercial food products, pet foods, and animal feed (Food Master (2003) Ingredients and R&D services catalog. Bensenville Ill. Business News Publishing Co. II. LLC). Quinoa protein is particularly high in lysine and methionine (Koziol, M J (1992) J. Food Composition and Analysis 5: pp. 35-68), and is also high in histidine, an essential amino acid for those with chronic diseases (Ettinger, S (2000) In: Mahan K L, Escott-Stump S, eds. Krause's Food, Nutrition, and Diet Therapy, 10th ed. Philadelphia, Pa. WB Saunders Co. pp. 54-61). In South America, it has been used as a weaning food for centuries because of its nutritional attributes and high protein digestibility. Few plant proteins so closely resemble that of animal origin as quinoa protein.

The following eight foods account for 90% of all food allergenic reactions: soy, wheat, eggs, milk, peanut, tree nuts, fish and shellfish (Hefle, S. L. et al. (1996) Crit. Rev. Food Sci. Nutr. 36(5): pp. 69-89). Food allergens are a serious concern because essential nutrients for proper health can be missing with a narrowed food choice, in addition to the life-threatening concern of anaphylactic shock in highly sensitive individuals. Allergens are problematic for food producers because many food ingredients fall into this category and limit product development. The impact that food allergens, including undeclared food allergens, have had on the food industry is significant and the FDA has made food allergens a top priority in recent years (Hefle, S. (September 2003) Symposium: Update on Food Allergens. American Association of Cereal Chemists Annual Meeting. Portland, Oreg.). Notably, quinoa is not on the list of recognized food allergens. It is considered free of gluten or prolamins (Fairbanks, O J et al. (1990) Plant Breeding 104(3): pp. 190-195), the proteins associated with allergenic reactions in wheat gluten, rye and barley. Prolamins, like gliadins found in wheat, trigger immune responses in patients with gluten-induced enteropathy, also known as celiac disease.

Quinoa is a dicotyledonous species not closely related to the monocotyledonous species of true cereal grains like wheat, rye, and barley. As a result of differences in plant taxonomy, quinoa does not contain the harmful amino acid sequences found in wheat. Therefore, it is concluded safe for a gluten-free diet (Thompson, T. (2001) J. Am. Diet. Assoc. 101: pp. 586-587) and is recommended by the Celiac Disease Foundation and Gluten Intolerance Group. Furthermore, research presented at the International Workshop on Food Supplementation in Food Allergy and Immunity, found that quinoa is immunochemically safe and represents a viable alternative for gluten-free products (Berti, C et al. (August 2002) International Workshop on Food Supplementation in Food Allergy and Immunity. Olsztyn).

Kosher rules require that certain food products not be eaten, such as hare, pig, lobster, oyster, shrimp, clam and crab, or food products not be combined, such as animal meats and permissible seafood, or animal meats and dairy. Processed items, like dry cereals, baked goods, canned and frozen fruits and vegetables, and dried fruits, can be problematic, since these products may include small quantities of non-kosher ingredients during cooking and processing in factories using equipment that is also used for non-kosher foods. Likewise, processed products may include packaging or processing using animal fats. During Passover, kosher rules are more stringent, requiring additional food restrictions such as prohibitions against leavened products. Products made from the grains wheat, rye, barley, spelt, and oats, identified collectively as “chometz”, which might have been inadvertently moistened after harvest and therefore begun to ferment, are regarded as leavened and prohibited during Passover.

Beer is normally made from kosher ingredients: water, barley, yeast, and hops. However, during Passover this presents a problem, as the ingredients of beer include prohibited chometz. The Torah prohibits the consumption or possession of chometz throughout Passover (Exodus 13:3) that came into contact with water for more than 18 minutes. Therefore, beer and other traditional fermented beverages cannot be consumed or owned during Passover. Products have been brought to market that are gluten free, such as malt of sorghum, or are Kosher for Passover, such as sugar and maple syrup-brewed “beer”. No malted products have been available that are both gluten free and Kosher for Passover. However, because quinoa is not chometz, it is permitted on Passover even for Ashkenazim, as it is technically not a cereal grass family member.

Despite the numerous beneficial properties of quinoa as a plant protein source with no known allergenic properties, and favorable kosher status, the processing of quinoa grain has received little attention. Quinoa has not been processed into consumable beverages. Therefore, there is a need in the art to develop a method to process quinoa grains for consumption as a beverage. The advantages of the invention will be evident in the following description.

### SUMMARY OF INVENTION

The present invention provides a non-obvious method for manufacturing a quinoa beverage. Quinoa is considered to be hypo-allergenic (even non-allergenic), as opposed to key plant allergens, soy and wheat. The method can be characterized by the steps of: 1) pre-conditioning quinoa grain; 2) conditioning the quinoa grain; 3) malting (germinating) the grain to produce green quinoa malt; 4) kilning the quinoa grain; 5) optional milling of the grain to expose the proteins and carbohydrates; 6) mashing the malted quinoa to form a wort; 7) lautering the wort to remove the spent grain by-product; 8) boiling the wort with optional hops and/or clarifiers followed by cooling the wort; and 9) fermenting the wort by the addition of yeast. The method yields a liquid quinoa product with a fermented-sugar product similar to beer or distilled alcohol with the novel characteristics as discussed above. Prior to pre-conditioning, conditioning, or malting, quinoa grain can be sorted by size, shape, or color to aid in quality of finished products.

The brewed or distilled quinoa product is made by pre-conditioning a quinoa grain. The pre-conditioning may be accomplished by mechanically abrading a peri-carp of the quinoa grain, washing the quinoa grain, polishing, peeling, aspiration, air classification, sieving, pneumatic pressure, vacuum, nixtamalization, rinsing, solvent leaching, or combinations thereof. In particular, the quinoa may be washed by covering the grain with fresh water at 10 to 15° C. and at a ratio of quinoa to water (w/v) of 0.1:1 or 0.5:1; 2:1; 3:1; 4:1; 5:1; 20:1 or 1:1, gently agitating the wash for 1 minute, and draining the water off the quinoa; and repeating the wash and draining for 2 to 10 times. The quinoa grain is then conditioned. In particular, the conditioning may be performed by rinsing the pre-conditioned quinoa grain with clean water, after which the quinoa grain is soaked with clean water to increase the water content to about 12 to 60% moisture content of grain. It is advantageous to soak the quinoa at a range of 7.5 to 12.5° C. for 30 seconds to 720 minutes to obtain the necessary water content, and in particular variations may be soaked at 10±2.5° C. for 4 hours. The quinoa may be rinsed with clean water at a quinoa to clean water ratio of 0.1:1, 0.5:1; 2:1; 3:1; 4:1; 5:1; 20:1 or 1:1 before soaking the quinoa grain. The grain is then malted (germinated) in a climate controlled environment at a temperature range of 4 to 40° C. for a time range of 2 hours to 14 days. For example, the quinoa grain may be germinated at 10±2.5° C. for 96±24 hours. The quinoa grain may also be germinated with circulating air, to maintain a grain moisture content of about 35% to about 45%.

After malting (germinating), the quinoa grain is kilned at a temperature range of 37.8 to 85° C. for a predetermined time, such as at 65° C. for 4±0.5 hours. The quinoa grain may also be kilned with continuous air flowing through and over the grain. The kilned quinoa is optionally milled to crack the seed coat in preparation for mashing.

The quinoa grain is then mashed to form wort. The mashing comprises adding the kilned quinoa to fresh water heated to a predetermined temperature, such as a preheated temperature of about 76.7° C., and steeping the kilned quinoa in the fresh water at a temperature of at or below 78.8° C. The method is found to work particularly well where the mash uses 1 quart of fresh water per pound of malted quinoa grain. At these conditions, the mash is preferably steeped for 1 hour. The mashing is then followed by lautering, by removing the spent quinoa grain from the wort. The wort is boiled, optionally using hops, clarifiers, and any other flavorants desired. Examples of useful hops include an initial hops addition (bittering hops) of Saaz, Strissel, Spalt, Fuggles, Goldings, like East Kent Goldings, Bullion, Cascade hops, Columbus hops, Centennial hops, Willamette hops, Amarillo hops, Hallertau or Hallertauer, Hersbrucker, Tettnang hops, or combinations thereof. In particular, the bitter hops can be 1 ounce of Cascade hops for every 7.5 gallons of wort, and 0.5 ounce of Hallertau hops for every 7.5 gallons of wort. In some variations, a finishing hops and clarifier are added after 30 minutes of boiling. The finishing hops may be Saaz, Strissel, Spalt, Fuggles, Goldings, like East Kent Goldings, Bullion, Cascade hops, Columbus hops, Centennial hops, Willamette hops, Amarillo hops, Hallertau or Hallertauer, Hersbrucker, Tettnang hops, or combinations thereof, and the clarifying agent is isinglass, Irish moss, kappa carrageenan, Polyclar, or gelatin. More particularly, the finished hops may be 0.75 ounces of Cascade hops for every 7.5 gallons of wort, and 0.5 ounces of Hallertau hops for every 7.5 gallons of wort. The clarifying agent may be ¼ teaspoon of Carrageenan for each 5 gallons of wort. At this stage, other spices and flavorants may also be added, where desired.

The wort is then cooled down to fermentation temperatures, of about 20 to about 26° C., and fermenting yeast added to the wort. Useful fermenting yeast includes Saccharomyces cerevisiae. Where S. cerevisiae is used the fermentation may be performed at 15 to 24° C. The wort is fermented in a sealed, air locked vessel. The fermented wort is then optionally conditioned. Alternatively, the fermented wort is collected for distillation.

Where the product is distilled, the fermented wort is transferred into a distillation still. Any distillation system known in the art is acceptable, however particularly useful examples include a single pot still, a multiple-pot still, a column still, a continuous still, or a Coffey still. The fermented wort is boiled to form an evaporate, and the evaporate collected. The collections of evaporate are allowed to condense into a distillate and the distillation optionally aged. Aging may be performed as known in the art. Useful examples are aging in an oak cask, a white oak cask, an apple wood cask, a red oak cask, an alder wood cask, a hickory cask, a maple wood cask, a French oak cask, a spruce cask, a pine cask, a charred oak cask, a charred white oak cask, a charred apple wood cask, a charred red oak cask, a charred alder wood cask, a charred hickory cask, a charred maple wood cask, a charred French oak cask, a charred spruce cask, a charred pine cask, or a combination thereof. In some variations, the distilled spirits are aged in used casks, such as sherry casks. Where the ageing is done in sherry casks for the final distilled product to be Kosher for Passover and gluten-free, the source of the casks must be from the manufacture of Kosher for Passover sherry. Bourbon casks may be used for ageing, however this would render the final aged product neither Kosher for Passover nor gluten free.

### BRIEF DESCRIPTION OF THE DRAWINGS

For a fuller understanding of the invention, reference should be made to the following detailed description, taken in connection with the accompanying drawings, in which:

FIG. 1 is a schematic showing the quinoa brewing process.

FIG. 2 is a schematic showing the quinoa distillation process.

### DETAILED DESCRIPTION OF THE PREFERRED EMBODIMENT

In general the terms and phrases used herein have their art-recognized meaning, which can be found by reference to standard texts, journal references and contexts known to those skilled in the art. The following definitions are provided to clarify their specific use in the context of the invention.

The term, “quinoa product”, as used herein, is intended to indicate the product obtained from processing quinoa (Genus: Chenopodium, Species: quinoa, Family: Chenopodiaceae) grain (also called quinoa seed, grain-like seed, pseudocereal, and fruit).

The term “pre-conditioning” is used herein to indicate a step of treatment to remove saponins in the quinoa grain. Saponins are concentrated in the pericarp of quinoa. Saponin removal can be achieved via mechanical abrasion, washing, or a combination of both.

The term “conditioning”, or “conditioned”, is used herein to indicate treatment to adjust the moisture content of the quinoa grain.

The term “malting”, “malted”, “malt” “germination”, or “germinated” or “germinating”, is used herein to indicate a step of treatment to increase enzyme activity, maintain fermentable carbohydrates, and control microbial growth, such as regulating the sprouting of quinoa grain in such a manner to increase enzyme activity, maintain fermentable carbohydrates, and control microbial growth.

The term “mashing”, is used herein to indicate a step of treatment where the germinated, mostly dry, quinoa is added to excess water to create a slurry which pulls the carbohydrates into the solution, such as by heat tempering.

As used herein, the term “beer” shall refer to malt alcoholic beverages. This includes, without limiting the scope of the invention, beer, ale, porter, stout, and malt liquor.

The general process of preparing fermented malt beverages, such as beer, porter, ale, malt liquor, and other similar fermented alcoholic beverages is known. As practiced in modern breweries, a “mash” of malt, containing cereals, is heated to solubilize the proteins and convert the starches into sugar and dextrins. The insoluble grains are removed and washed with hot water, with the wash combined to the soluble material. The resulting wort is boiled to inactivate enzymes and sterilize the wort. Hops and other additives are added at this stage and protein substances coagulated. The wort is then strained to remove hops and coagulant, and cooled. The wort is fermented with yeast, like Saccharomyces cerevisiae or Saccharomyces pastorianus, followed by finishing of the beer and filtering.

The present invention provides a non-obvious method for manufacturing a brewed quinoa product. The method can be characterized by the steps of: 1) pre-conditioning quinoa grain; 2) conditioning the quinoa grain; 3) malting (germinating) the grain; 4) kilning and optionally roasting the quinoa grain; 5) optionally milling of the grain to expose the proteins and carbohydrates; 6) mashing the malted quinoa to form a wort; 7) lautering the wort to remove the spent grain by-product; 8) boiling the wort with optional hops and/or clarifiers; and 9) adding fermenting yeast to the wort. The method yields a liquid quinoa product with a fermented-sugar product similar to beer with the novel characteristics as discussed above. Prior to pre-conditioning, conditioning, or germination, quinoa grain can be sorted by size, shape, and/or color to aid in quality of finished products.

Where the final beverages are to be Kosher for Passover, particular care must be taken in selecting only Kosher for Passover ingredients (i.e. yeast, flavorants, clarifiers), brewing equipment, stills, ageing/storage containers, and bottles. Likewise, any product that is to be gluten-free may not have gluten-containing ingredients and cannot be processed or stored in materials that will leach gluten into the final beverage.

### EXAMPLE 1

The quinoa grain is first pre-conditioned for enhanced flavor. The bitter or unpleasant taste attributed to quinoa is caused by saponins that are concentrated in the peri-carp of quinoa grain. Saponins are a group of amphipathic plant glycosides that form soapy lathers when mixed and agitated with water. They are frequently used in detergents, foaming agents, and emulsifiers. Saponins are often bitter to taste, reducing plant palatability to livestock and other animals ingesting the saponin-containing plant (e.g., in livestock feeds), or even imbue them with potentially life-threatening toxicity, depending upon the plant species and the quantity ingested. Processing of quinoa is limited, mainly to solid consumable products as described in Scanlin, et al. (U.S. application Ser. No. 12/748,968) and Scanlin, et al. (U.S. Pat. No. 7,563,473).

The pre-conditioning step removes the saponin through mechanical abrasion, washing the quinoa grain and combinations thereof. The number of washings can be adjusted in the range of one to ten washings. In an advantageous embodiment the pre-conditioning includes washing the quinoa by covering the grain with fresh water (10 to 15° C.; 50 to 59° F.). The ratio of quinoa to water (w/v) can be adjusted to include ratios such as 0.1:1 or 0.5:1; 2:1; 3:1; 4:1; 5:1; 20:1 or similar ratios, preferably 1:1, with a ratio of 5:1 of particular use. The wash is followed by gentle agitation for 1 min. The rinse water is then drained off. This procedure was repeated 2 to 3 times. The quick wash removes saponins and also minimizes penetration of the water-soluble saponins into the grain. The quick washes can alternatively include stirring, agitation, spray or counter current extraction followed by draining or centrifugation, again minimizing penetration of water-soluble saponins into the grain. In some embodiments, the first quick wash uses a residence time of about 30 seconds to about 2 minutes, with preferred washes under 1 minute. Subsequent (secondary) washes use a residence time of about 2 minutes to about 10 minutes, with preferred secondary washes at or under 5 minutes. Such a washing scheme is found to be particularly effective in reducing the presence of saponins in the grain. Alternatively, the pre-conditioning can utilize techniques such as mechanical abrasion, washing, polishing, peeling, aspiration, air classification, sieving, pneumatic pressure, vacuum, nixtamalization, rinsing, solvent leaching the quinoa grain and combinations thereof. Where mechanical abrasion is used, the abrasion is quickly followed by an initial wash with stirring, agitation or spray or counter current extraction immediately followed by draining or centrifugation to minimize penetration of the water-soluble saponins into the seed coat.

After pre-conditioning, the quinoa grain is conditioned. The moisture content can be adjusted by the addition or removal of water. A preferred conditioning technique includes the addition of clean water to quinoa grain immediately after pre-conditioning. In general, the quinoa is rinsed by running fresh water (10 to 15° C.; 50 to 59° F.) over the surface of the grain while simultaneously draining off the water from beneath the grain bed. Afterwards, the quinoa is soaked to increase the water content (% Hydration). Clean water is used because the water from the previous pre-conditioning contained the saponins that leached from the quinoa grain. The ratio of quinoa to clean water (w/v) can be adjusted to include ratios such as 0.1:1 or 0.5:1; 2:1; 3:1; 4:1; 5:1; 20:1 or similar ratios, preferably 1:1. As noted, the soaking generally occurs in clean/fresh water (10 to 15° C.; 50 to 59° F.). Residence time of the soak can be adjusted in the range of 30 seconds to 720 minutes (12 hours) depending on a given variety of quinoa, preferably about 4 hours. Soaking may occur at temp range of 7.5 to 12.5° C. (45.5 to 54.5° F.), with the conditions preferably being performed in a climate controlled environment of 10±2.5° C. (50±4.5° F.). The quinoa grain will absorb water and increase in moisture content in the range of about 12 to 60% moisture content of grain, preferably about 40% to about 50%.

The quinoa is malted by laying out the grain on flat trays after removal of excess water, and allowing the quinoa to germinate in a climate controlled environment. Germination may occur at a temperature range of 4 to 40° C. (39.2 to 104° F.), or at 5 to 30° C. (41 to 86° F.), preferably about 5° C. to about 15° C. (about 41 to 59° F.), most preferably in a controlled environment of 10±2.5° C. (50±4.5° F.). In some embodiments, it is also useful to circulate air through the quinoa grain and allow the quinoa grain to maintain moisture content of about 35% to about 45% during the germination process. Residence time of germination can be adjusted in the range of 2 hours to 14 days depending on a given variety of quinoa and germination temperatures, more preferably about 48 hours to about 72 hours, most preferably for 96±24 hours, or until full maturation of the acrospire. At the end of germination the quinoa grain is called “green quinoa malt.” After germination, the quinoa is kilned at a temperature of 37.8 to 85° C. (100-185° F.), preferably at 51.7 to 80° C. (125 to 176° F.), and more preferably 65° C. (149° F.). Kilning times depend on the temperature used and degree of kilning and flavor desired. For example, at 65° C. (149° F.), the quinoa is preferably kilned for 4±0.5 hours. Kilning may be performed with continuous air flowing through and over the grain, interrupting the germination process.

The grain may then be milled to break the solid material into smaller pieces. The grinding of solid matters occurs under exposure of mechanical forces that trench the structure by overcoming of the interior bonding forces. After the milling, the grain size, the grain size disposition and the grain shape have been altered for improved mashing.

The milled or otherwise malted quinoa grain is mashed. The malted quinoa is infused with 1 qt of fresh water, known as “liquor”, per 1 lbs of malted quinoa product. The fresh water is preheated to about 76.7° C. (170° F.), and added to mash tun previously prepared with mesh sparge bag lining the vessel. While other temperatures are envisioned, the temperature should be below 78.8° C. (174° F.). The malted quinoa grain is slowly added to the tun while the liquor is gently stirred, preventing formation of a dough ball. In specific variations, the quinoa was previously milled, and the cracked malted quinoa added. After quinoa is thoroughly mashed in, the temperature is assessed and adjusted by adding hot or cold water as needed to reach a final mash temperature of between 65.6 to 70° C. (150 to 158° F.), preferably between 65.6 to 68.3° C. (150 to 155° F.), most preferably at 65.6° C. (150° F.). The mash is then steeped for 1 hour, allowing enzymes to digest the proteins and carbohydrates in the grain and form wort.

Other mashing methods are envisioned, such as step infusion mashing using 1 qt of fresh water per 1 lbs of malted quinoa, double mashing processes which are well known in the art as described in Bisgaard-Frantzenm, et al. (U.S. application Ser. No. 10/520,956), step infusion (Bisgaard-Frantzenm, et al.; U.S. application Ser. No. 10/520,956), and decoction. Decoction is also known in the art as a mashing method removing a portion of the mash and boiled separately before returning to the original mash, as described in Mulder (U.S. application Ser. No. 12/301,440).

Alternatively, the mashing stage may use a recycling infusion mash or recirculating infusion mash system (RIM system). The RIM system recirculates the mash from the bottom of the mash back to the top. In some variations, the RIM system uses paddles to stir the mash ever so slowly thus keeping consistent temperatures in the tun. The RIM system uses a pump in combination with a heat source to recirculate and heat the mash. As the wort from the mash flows out of the mash tun, through a false bottom and through a pump, it travels into the heating chamber or past a heating element. The heat may be applied by an electric heating element suspended in a tube after the pump, applied via direct heat under a metal mash tun (flame or electric). A sensor reads the recirculating wort's temperature before it enters the heating chamber and the heating chamber adjusts the wort's temperature as needed. The wort then reenters the mash tun.

Instead of a RIM system, the mash may use a heat-exchanged recirculating mash system (HERMS), which recirculate the wort from the mash tun through a heat exchanger and back into the mash tun. The heat exchanger may be any type known in the art, such as a copper manifold suspended in hot liquid.

The temperature of the recirculated wort is controlled by the heat exchanger which, as a result, controls the temperature of the mash precisely.

### EXAMPLE 2

The wort produced in Example 1 is then separated from the grain by-products by lautering. To lauter the wort, the sparging bag containing the spent quinoa grain is raised from the wort, so that the bottom of the bag is fully cleared of the wort. The sparging bag is allowed to drain by gravity for 15 minutes, or until drainage stops and the sparge bag removed. The liquid wort (first wort extract) is then transferred to the boiling vessel.

The sparging bag containing the spent grain is returned into the mash tun. One qt of fresh hot water (76.7° C.; 170° F.) per 1 lbs of malted quinoa is added to the sparge bag, over the spent grains. The sparging bag containing the quinoa grain is again removed and the wash is added to the first wort extract. The additional lautering should bring the approximate volume of wort in the boil vessel to the desired volume of ½ gallon/pound of malted quinoa.

Other lautering methods are contemplated, such as continuous lautering. The wort is added to a mash tun outfitted with a false bottom, a lauter tun, or a mash filter. The wort extract is separated from the spent grains as described above, followed by sparging using the filter, grate, or other size separation system built into the mash tun, lauter tun, or mash filter.

Where a RIM or HERMS system is used for mashing, the lautering step may be performed by draining the wort through the false bottom of the mash tun. The remaining, spent grain may then be rinsed as described above.

The wort is then transferred into a boil vessel and the temperature of the wort is raised to full rolling boil. The heat temporarily turned off to add the bittering hops. The bittering hops can be any hops known in the art, such as Saaz, Strissel, Spalt, Fuggles, Goldings, like East Kent Goldings, Bullion, Cascade hops, Columbus hops, Centennial hops, Willamette hops, Amarillo hops, Hallertau or Hallertauer, Hersbrucker, and Tettnang hops. The amount of hops added depends on taste and variety of hops. Preferably, Cascade hops are added at 1 oz/7.5 gallons (1 oz for every 7.5 gallons of wort) and 0.5 oz/7.5 gallons of Hallertau hops. The wort is then returned to full rolling boil, with stirring to prevent boil over. The wort is boiled for 30 minutes and removed from heat to add the finishing hops and clarifying agent. The finishing hops can be any of the bittering hops types listed above, with varying amounts and combinations based on the flavor desired. For example, finishing hops may include 0.75 oz/7.5 gallons of Cascade hops and 0.5 oz/7.5 gallons Saaz. The clarifying agent used may be any known in the art, including without limitation isinglass, Irish moss, kappa carrageenan (carageenan, from Kappaphucus cottonii), Polyclar, and gelatin. In embodiments where the product is to be Kosher, the clarifying agents must also be an acceptable clarifying agent. Preferably, the clarifying agent is ¼ teaspoon of Carrageenan for each 5 gallons of wort. The wort is returned to full rolling boil for 10 minutes, with stirring to prevent boil-over of the wort.

Additional spices and/or special ingredients are added before the last boil. Non-limiting examples of spices and ingredients include honey, molasses, maple syrup, fruits, pumpkin, and cedar wood chips. In embodiments where the products are being sold as Kosher and gluten-free, all the ingredients, additives, and agents must be gluten-free and Kosher for Passover use.

The boiling wort must be brought down to fermentation temperatures (20 to 26° C.; 68 to 78.8° F.) before yeast is added. The wort is chilled by running the wort through a coil immersed in ice water, a refrigerant line, or any other heat exchange device, to rapidly reduce its temperature prior to flowing into the fermentation vessel. Cool water is added to the fermentation vessel to achieve the full desired volume of beverage in accordance with the original recipe, compensating for liquid losses due to boiling and evaporation. For example, where the original recipe called for 1 gallon of water for each 2 pounds of malted quinoa, and the fermentation vessel contains a lesser volume of wort, cool water is added to restore the wort to the full recipe volume. Prior to addition of yeast or prior to flowing into the fermentation vessel, the chilled wort may also be oxygenated, such as by aeration, bubbling sterile air, or any other method known in the art.

Yeast is then added to the fermentation vessel with the wort, and the vessel sealed and air locked. The fermentation vessel may be any known in the art, such as cylindro-conical tanks. Any yeast known useful for production of beer which is both gluten-free and Kosher for Passover use may be used, such as Saccharomyces cerevisiae. Particularly useful S. cerevisiae yeast is the SafAle S-04 strain. The yeast ferments at temperatures between 15 to 20° C. (59 to 68° F.), with maximum temperatures up to 24° C. (75° F.). In specific embodiments of the invention, the wort is fermented at a steady temperature of 17.5° to 22.5° C. (63.5 to 72.5° F.).

Where the SafAle S-04 strain of Saccharomyces cerevisiae is used, the dry yeast is added directly into the fermentation vessel containing the wort at a temperature above 20° C. (68° F.). The dry yeast is progressively sprinkled into the wort, avoiding clumps. The yeast is allowed to rest for 30 minutes and then the wort and yeast are mixed by known methods, such as aeration. Alternatively, the dry yeast is re-hydrated into yeast cream in a stirred vessel prior to pitching. The dry yeast is diluted in 10 times its own weight of sterile water or wort at 27° C.±3° C. (80.6±5.4° F.) and gently stirred for about 15 to 60 minutes, with the suspended yeast mixed with gentle stirring for 30 minutes. The yeast cream is then added to the fermentation vessel.

The yeast is allowed to ferment for about two weeks to three months after the beginning of fermentation, with particularly useful fermentation occurring at two to three weeks, and more particularly two weeks. After the yeast has fermented for a period of two weeks, in the climate controlled environment described above, the beer is removed from the fermentation vessel and conditioned.

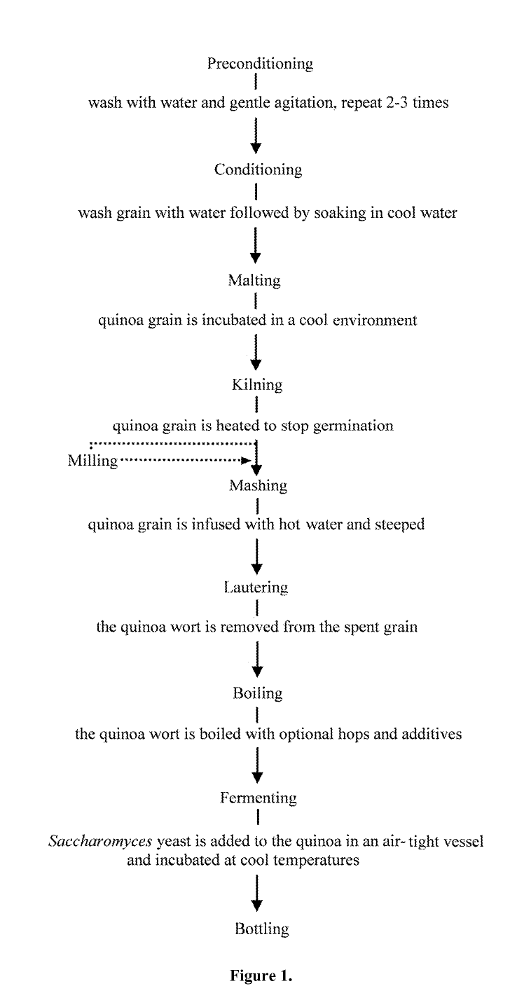

During the fermentation, the sugars are digested, which slows as the process progresses and the yeast settles to the bottom of the fermentation tank. At this stage, the beer is conditioned by bottle conditioning. Useful bottle conditioning instructions are described in Advanced Bottle Conditioning (Northern Brewer, St. Paul, Minn.). Other conditioning methods are also envisioned, such as filtering and forced carbonation for conditioning the final product before bottling. The general scheme to prepare this quinoa brewed beverage is shown in FIG. 1.

### EXAMPLE 3

The wort produced in Example 1 is fermented with yeast, as described in Example 2. The wort may be lautered, as described in Example 2, before fermentation. Once the yeast has completed fermentation, the fermented wort is distilled. Optionally, the brewed malt beverage produced in Example 2 may be used in place of the fermented wort.

The fermented wort or brewed malt alcohol is placed into a distilling still. The still may be a single pot still, multiple-pot still, column still, or continuous still, such as a Coffey still. The still is made of any material known in the art. Non-limiting examples include copper, stainless steel, wood, and clay. Where a continuous still is used, the incoming fermented wort or brewed malt alcohol is pre-heated before entering the still. The incoming fermented wort or brewed malt alcohol is then heated with a heat source, as is known in the art, to form an evaporate.

The initial evaporate fraction obtained from the still is discarded. The remaining evaporate is allowed to condense and is collected as distilled spirit. The distilled spirit may then be placed into wood ageing casks to mature, such as oak casks. In some embodiments, the distilled spirit is ages for a minimum of 2 years.

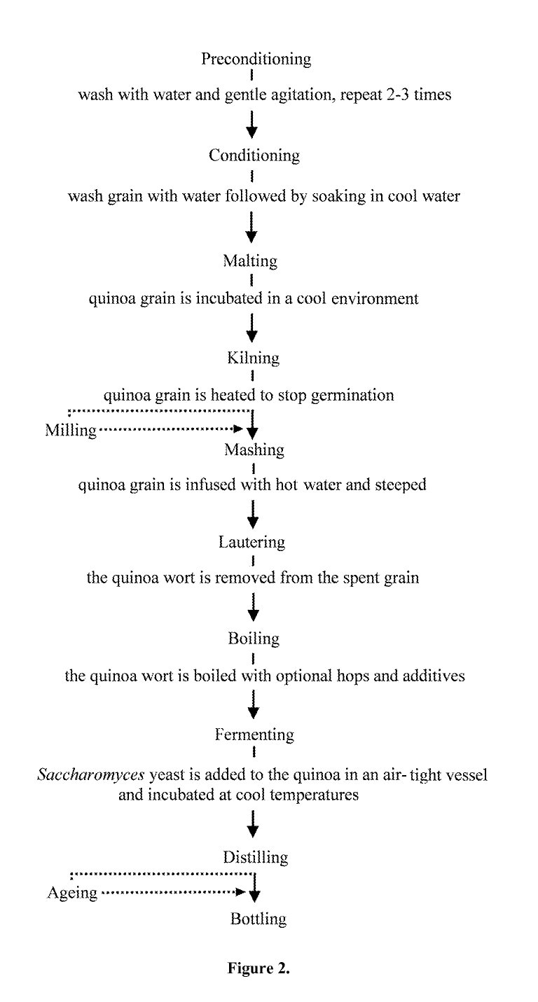

The general scheme to prepare this quinoa distilled beverage is shown in FIG. 2.

In the preceding specification, all documents, acts, or information disclosed does not constitute an admission that the document, act, or information of any combination thereof was publicly available, known to the public, part of the general knowledge in the art, or was known to be relevant to solve any problem at the time of priority.

The disclosures of all publications cited above are expressly incorporated herein by reference, each in its entirety, to the same extent as if each were incorporated by reference individually.

While there has been described and illustrated specific embodiments of a method of making quinoa beverages, it will be apparent to those skilled in the art that variations and modifications are possible without deviating from the broad spirit and principle of the present invention. It is also to be understood that the following claims are intended to cover all of the generic and specific features of the invention herein described, and all statements of the scope of the invention which, as a matter of language, might be said to fall therebetween.

What is claimed is:

1. A method of brewing a quinoa-based beverage, comprising:
obtaining a malted quinoa extract;
boiling the malted quinoa extract to form boiled wort;
cooling the boiled wort down to fermentation temperatures, where the fermentation temperatures are about 20 to about 26° C.; and
adding fermenting yeast to the wort and fermenting the wort is an air locked vessel sealed.

2. The method of claim 1, wherein the malted quinoa extract is prepared by the steps:
pre-conditioning a quinoa grain comprising mechanically abrading a peri-carp of the quinoa grain, washing the quinoa grain, polishing, peeling, aspiration, air classification, sieving, pneumatic pressure, vacuum, nixtamalization, rinsing, solvent leaching, or combinations thereof;
malting the grain in a climate controlled environment at a temperature range of 4 to 40° C. for a time range of 2 hours to 14 days;
kilning the quinoa grain at a temperature range of 37.8 to 85° C.;
mashing the malted quinoa to form a wort, comprising adding the kilned quinoa to fresh water heated to a predetermined temperature and steeping the kilned quinoa in the fresh water at a temperature of at or below 78.8° C.; and
lautering the wort comprising removing the spent quinoa grain from the wort.

3. The method of claim 2, wherein the pre-conditioning of quinoa grain further comprises:
washing the quinoa, wherein the washing comprises covering the grain with fresh water at 10 to 15° C. and at a ratio of quinoa to water (w/v) of 0.1:1 or 0.5:1; 2:1; 3:1; 4:1; 5:1; 20:1 or 1:1;
gently agitating the wash for 1 minute; draining the water of the quinoa; and
repeating the above steps 2 to 10 times.

4. The method of claim 2, further comprising conditioning the quinoa grain, wherein the condition comprises:
rinsing the pre-conditioned quinoa grain with clean water; and
soaking the quinoa grain with clean water to increase the water content to about 12 to 60% moisture content of grain.

5. The method of claim 4, wherein the quinoa grain is rinsed at a ratio of quinoa to clean water of 0.1:1, 0.5:1; 2:1; 3:1; 4:1; 5:1; 20:1 or 1:1.

6. The method of claim 4, wherein the quinoa grain is soaked at a range of 7.5 to 12.5° C. for 30 seconds to 720 minutes.

7. The method of claim 6, wherein the quinoa grain is soaked at 10±2.5° C. for 4 hours.

8. The method of claim 2, wherein the quinoa grain is malted at 10±2.5° C. for 96±24 hours.

9. The method of claim 2, wherein the quinoa grain is malted with circulating air, wherein the air maintains a grain moisture content of about 35% to about 45%.

10. The method of claim 2, wherein the quinoa grain is kilned at 65° C. for 4±0.5 hours.

11. The method of claim 2, wherein the quinoa grain is kilned with continuous air flowing through and over the grain.

12. The method of claim 2, further comprising milling the quinoa grain.

13. The method of claim 2, wherein the mash uses 1 quart of fresh water per pound of malted quinoa grain.

14. The method of claim 13, wherein the fresh water is preheated to about 76.7° C.

15. The method of claim 2, wherein the mash is steeped for 1 hour.

16. The method of claim 2, wherein the mash is at a final temperature of 65.6 to 70° C.

17. The method of claim 1, further comprising adding hops to the wort during the initial stages of boiling, wherein the hops are Saaz, Hallertau, Strissel, Spalt, Fuggles, Goldings, East Kent Goldings, Bullion, Cascade hops, Columbus hops, Centennial hops, Willamette hops, Amarillo hops, Hersbrucker, Tettnang hops, or combinations thereof.

18. The method of claim 17, wherein the hops is Cascade hops added at 1 ounce for every 7.5 gallons of wort, and Hallertau hops added at 0.5 ounce for every 7.5 gallons of wort.

19. The method of claim 1, further comprising adding hops and clarifying agent to the wort after 30 minutes of boiling,
wherein the hops are Saaz, Hallertau, Strissel Spalt, Fuggles, Goldings, East Kent Goldings, Bullion, Cascade hops, Columbus hops, Centennial hops, Willamette hops, Amarillo hops, Hersbrucker, Tettnang hops, or combinations thereof; and
wherein the clarifying agent is isinglass, Irish moss, kappa carrageenan, Polyclar, or gelatin.

20. The method of claim 19, wherein the hops is Cascade hops added at 0.75 ounces for every 7.5 gallons of wort, and Hallertau hops added at 0.5 ounces for every 7.5 gallons of wort.

21. The method of claim 19, wherein the clarifying agent is ¼ teaspoon of Carrageenan for each 5 gallons of wort.

22. The method of claim 1, further comprising adding spices and other flavorants to the boiling wort.

23. The method of claim 1, wherein the fermenting yeast is Saccharomyces cerevisiae.

24. The method of claim 1, wherein the fermentation is performed at 15 to 24° C.

25. The method of claim 1, further comprising conditioning the fermented wort.

26. The method of claim 1, further comprising:
collecting the fermented wort;
ensuring the fermented wort is not carbonated;
placing the fermented wort into a distillation still;
boiling the fermented wort to form an evaporate;
collecting fractions of the evaporate; and
allowing the collections of evaporate to condense into a distillate.

27. The method of claim 26, further comprising aging the distillate.

28. The method of claim 27, wherein the distillate is aged in an oak cask, a white oak cask, an apple wood cask, a red oak cask, an alder wood cask, a hickory cask, a maple wood cask, a French oak cask, a spruce cask, a pine cask, a charred oak cask, a charred white oak cask, a charred apple wood cask, a charred red oak cask, a charred alder wood cask, a charred hickory cask, a charred maple wood cask, a charred French oak cask, a charred spruce cask, a charred pine cask, or a combination thereof.

29. The method of claim 28, wherein the cask is a cask used to age sherry or bourbon prior to aging the distillate.

30. The method of claim 26, wherein the distillation still is a single pot still, a multiple-pot still, a column still, a continuous still, or a Coffey still.
